(19) United States
(12) Patent Application Publication
(10) Pub. No.: US 2005/0244551 A1
(43) Pub. Date: Nov. 3, 2005

(54) Meat product package and packaging method with maintained atmosphere

(76) Inventor: Eldon Roth, Dakota Dunes, SD (US)

Correspondence Address: THE CULBERTSON GROUP, P.C., 1114 LOST CREEK BLVD., SUITE 420, AUSTIN, TX, 78746, US

(21) Appl. No.: 10/835,426

(22) Filed: Apr. 29, 2004

(51) Int. Cl. C12C 1/027

(52) U.S. Cl. 426/129

(57) ABSTRACT

A method includes sealing a meat product into a container. The method then includes releasing carbon dioxide gas from a source contained inside the container to maintain a carbon dioxide gas presence in the atmosphere within the container. Sufficient carbon dioxide gas is preferably maintained in the package along or together with one or more gasses to maintain at least a slight positive pressure in the container or package, that is, a pressure slightly above atmospheric pressure.

### TECHNICAL FIELD OF THE INVENTION

This invention relates to meat processing and meat packaging. More particularly, the invention relates to a meat packaging arrangement for maintaining a desired gas atmosphere within the package. The invention also encompasses a method for maintaining a desired gas atmosphere within a meat package.

### BACKGROUND OF THE INVENTION

It has become popular in recent years to process whole carcasses or carcass sections into smaller cuts or ground meat at a central processing facility, package the smaller cuts or ground meat, and then distribute the smaller cuts or ground meat to retailers and wholesalers in packaged form. Several different types of packages are used to distribute meat products in this distribution model. One type of package commonly used may be referred to as a tray-type package. A tray-type package includes a tray made from polystyrene or other suitable material. The meat product to be packaged is placed in the tray and then a sealing film material is sealed over a top opening of the tray to form a sealed container around the meat product. Another type of package commonly used for comminuted meats such as ground beef and sausage is referred to as a chub-type package. In chub packaging systems, the comminuted meat product is extruded into a tubular section of thin sheet material and then the sheet material is sealed around the product to form generally a cylindrical sealed container for the meat product.

Various gasses or mixtures of gasses in the package atmosphere surrounding a meat product may be used to help increase the shelf life of the packaged meat product. Packaging that controls the atmosphere surrounding the meat product is commonly referred to as modified atmosphere packaging or MAP. Carbon dioxide gas is an example of a gas commonly used in modified atmosphere packaging. Carbon dioxide gas has been used in modified atmosphere packaging in order to help maintain an anaerobic environment around the meat product and thereby inhibit the growth of aerobic microbes in the product. U.S. Pat. No. 5,352,467, for example, discloses a system in which a gas mixture including carbon dioxide gas is injected into a sealed package through a septum in the package.

One problem that arises in packaged meat products is the loss of liquids from the meat while the packaged meat product is in transit, in storage, or on display. The liquid lost from a meat product is commonly referred to as “purge.” In packaged meat products, the liquid or purge from the meat product collects in the package and may make the product less attractive to consumers.

The purge or loss of liquid from a packaged meat product may be increased where the atmosphere in the package is not maintained at an appropriate positive pressure. Loss of pressure within meat packaging may occur when material from the enclosed atmosphere is absorbed into the meat product or constituents of the meat product. The loss of pressure may be so great in some cases that the package material collapses inwardly toward the meat product. Although loss of atmosphere constituents into the packaged meat product may occur with any meat product, the loss may be particularly pronounced with certain combinations of meat product and atmosphere. For example, loss of pressure in a meat package may be particularly severe where the meat product has been treated with pH increasing material, and the package atmosphere includes a pH decreasing material such as carbon dioxide gas.

### SUMMARY OF THE INVENTION

The present invention provides a packaging arrangement which maintains a desired atmosphere or pressure in the package. The invention encompasses a packaging apparatus, a packaged meat product, and a packaging method. It is noted that the term “meat product” is used here and throughout this disclosure and the accompanying claims to refer to meat alone, including lean portions, fat, and related materials of beef, pork, poultry, or seafood, and to refer to meat that has been mixed with, or includes, additives such as flavorings, extenders, fillers, tenderizing agents, and other materials.

A method embodying the principles of the invention includes sealing a meat product into a container. The method then includes releasing carbon dioxide gas from a source contained inside the container to maintain a carbon dioxide gas presence in the atmosphere within the container. In particular, sufficient carbon dioxide gas is preferably maintained in the container or package along or together with one or more gasses to maintain at least a slight positive pressure in the container, that is, a pressure slightly above atmospheric pressure. Prior to sealing the meat product in the container, the meat product is preferably subjected to a vacuum and/or flushed with a suitable flushing gas.

Carbon dioxide gas may be released according to the present invention from solid carbon dioxide held within the container or from a carbon dioxide gas impregnated plastic or other material held within the container. Where solid carbon dioxide provides the source for carbon dioxide gas released into the container, the solid carbon dioxide may be held in an isolating container which prevents direct contact between the solid carbon dioxide and the meat product. The isolating container includes at least one wall or boundary material that is permeable to carbon dioxide gas to facilitate the release of carbon dioxide gas into the container/package atmosphere surrounding the meat product.

A packaged meat product according to the invention includes a meat product sealed in at least one container material together with a carbon dioxide gas releasing material contained within the sealed container with the meat. The present invention is applicable to meat product containers comprising tray-type packages, chub packages, or any other suitable meat product package or container. The invention has particular application where the meat product has been treated with a pH increasing material such as an ammonia-based pH in increasing material. As used in this disclosure and the accompanying claims, an ammonia-based pH increasing material comprises ammonia gas, gas mixtures including ammonia gas, and ammonium hydroxide solution or aqueous ammonia, together with any other pH increasing material derived from ammonia.

These and other advantages and features of the invention will be apparent from the following description of the preferred embodiments, considered along with the accompanying drawings.

### BRIEF DESCRIPTION OF THE DRAWINGS

FIG. 1 is a view in perspective of a packaged meat product embodying the principles of the invention.

FIG. 2 is a view in section taken along line 2-2 in FIG. 1 and showing alternative locations for a carbon dioxide gas releasing material within the scope of the present invention.

FIG. 3 is a view in perspective of an isolating container embodying the principles of the present invention.

FIG. 4 is a view in section taken along line 4-4 in FIG. 3.

FIG. 5 is a diagrammatic representation of a packaging apparatus that may be used to produce a packaged meat product as shown in FIGS. 1 and 2.

FIG. 6 is a representation of a chub package embodying the principles of the invention.

FIG. 7 is a block diagram showing a method of packaging meat products according to the present invention.

### DESCRIPTION OF PREFERRED EMBODIMENTS

The claims at the end of this application set out novel features which the Applicant believes are characteristic of the invention. The various advantages and features of the invention together with preferred modes of use of the invention will best be understood by reference to the following description of illustrative embodiments read in conjunction with the drawings introduced above.

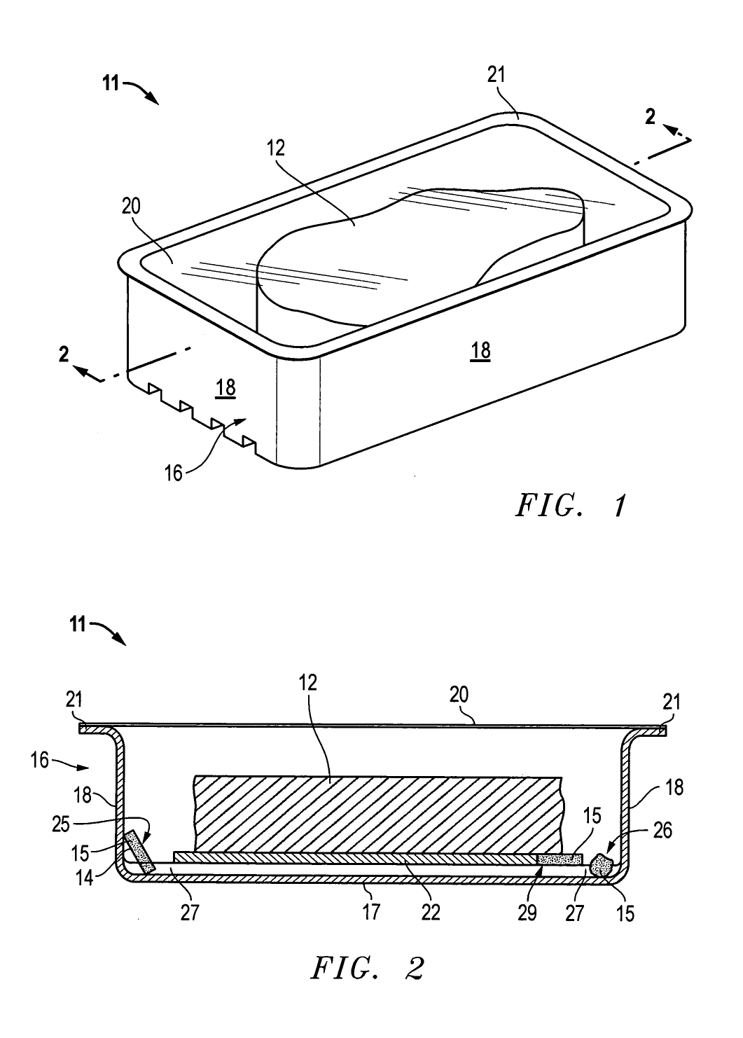

Referring first to FIGS. 1 and 2, a packaged meat product embodying the principles of the invention includes a sealed container 11 with a meat product 12 in an interior of the sealed container. As shown in FIG. 2, a carbon dioxide gas releasing material 15 is included in sealed container 11 together with meat product 12. The example packaging arrangement for the packaged meat product shown in FIGS. 1 and 2 comprises a tray-type package. This tray-type package is made up of a tray 16 having a bottom 17, side walls 18, and a top or tray opening having a periphery defined by a surface 21 at the top of the tray. A sealing film 20 is sealed to surface 21 to isolate an interior of the container 11 from the external atmosphere. A package atmosphere surrounds meat product 12 within the interior of container 11. FIG. 2 shows meat product 12 resting on an absorbent pad material 22 which is adapted to absorb purge from the meat product.

Any suitable materials may be used in a tray-type package employed according to the present invention. Trays such as tray 16 are commonly produced from closed cell polystyrene. The tray material may be any other material that is generally impermeable to gasses and liquids. The sealing film may comprise a polyvinyl chloride PVC film or any other suitable film that is generally impermeable to gasses and liquids.

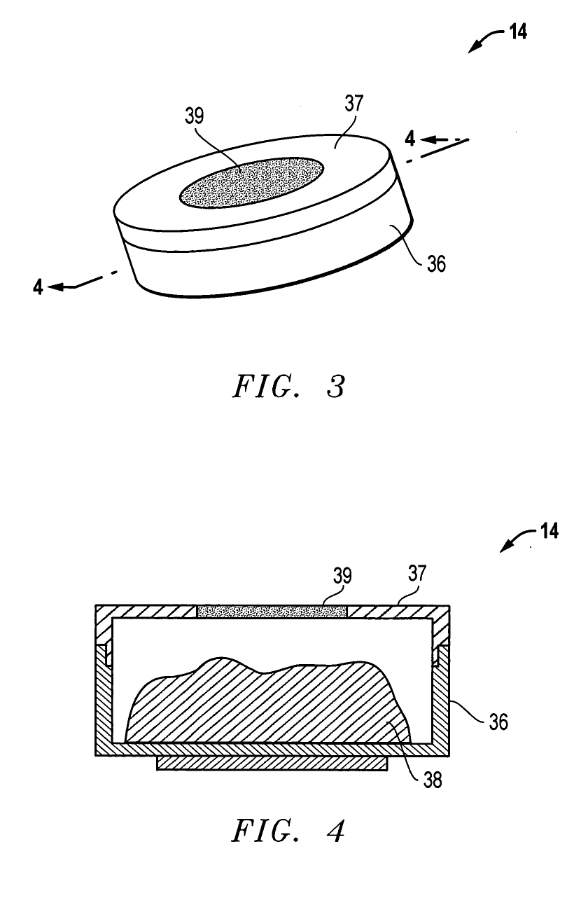

The carbon dioxide gas releasing material 15 is shown at three alternate positions in sealed container 11 in FIG. 2. In a first position shown generally at reference numeral 25, carbon dioxide gas releasing material 15 is shown in a suitable carrier or isolating container 14 resting at the bottom 17 of tray 16. Carbon dioxide carriers and isolating containers will be described below with reference to FIGS. 3 and 4. In a second position 26 shown in FIG. 2, carbon dioxide gas releasing material 15 is rests loosely in a channel or indentation 27 formed in the bottom 17 of tray 16. Channel or indentation 27 may be formed in tray 16 specifically to hold the carbon dioxide releasing material or may be included to improve the rigidity and strength of the tray. The final alternate position for carbon dioxide gas releasing material 15 shown in FIG. 2 is indicated generally at reference numeral 29. In this alternate position, the carbon dioxide gas releasing material 15 is carried by or incorporated into absorbent pad 22.

The carbon dioxide gas releasing material 15 within container 11 may comprise any material or combination of materials that is capable of releasing carbon dioxide gas into the atmosphere surrounding meat product 12. One preferred form of carbon dioxide gas releasing material 15 comprises solid carbon dioxide. Solid carbon dioxide may be contained loosely as one or more pellets, blocks, or flakes in sealed container 11 or may be contained in an isolating container such as the container 14 shown in FIG. 2, and described in greater detail below with reference to FIGS. 3 and 4. Where the carbon dioxide gas releasing material comprises solid carbon dioxide, the solid carbon dioxide is preferably placed in the sealed container out of direct contact with the meat product to prevent the solid carbon dioxide from releasing to gas too rapidly. Alternatively to solid carbon dioxide, carbon dioxide gas releasing material 15 may comprise a carrier material such as a suitable plastic or other material that is impregnated with carbon dioxide gas.

FIGS. 3 and 4 illustrate an isolating container 14 in which solid carbon dioxide may be contained within a sealed container such as container 11 shown in FIGS. 1 and 2. The primary function of isolating container 14 is to isolate the solid carbon dioxide from the meat products that are contained in the meat product container. Isolating container 14 may also help preserve the solid carbon dioxide and meter the release of carbon dioxide gas into a meat product container such as container 11.

Isolating container 14 comprises an enclosure having a base section 36 and a lid section 37, both made of a suitable material such as a suitable plastic. Base section 36 and lid section 37 are adapted to connected together with a frictional or other suitable engagement to form an enclosed area in which a supply of solid carbon dioxide 38 may be contained. Lid section 37 has associated with it a carbon dioxide gas permeable wall or boundary 39. This carbon dioxide gas permeable wall or boundary 39 allows carbon dioxide gas released from solid carbon dioxide 38 to exit isolating container 14 and enter the atmosphere surrounding the meat product in a sealed container for meat products such as container 11 in FIGS. 1 and 2. The carbon dioxide gas permeable wall or boundary 39 may include one or more small openings which allow carbon dioxide gas to escape from isolating container 14. Alternatively, carbon dioxide gas permeable wall or boundary 39 may include or be made from a material that is permeable to carbon dioxide gas without discrete openings. The permeability to carbon dioxide gas associated with wall or boundary 39 may be selected to allow carbon dioxide gas to meter slowly from the isolating container 14. This carbon dioxide gas metering arrangement may allow the supply of solid carbon dioxide to last for an extended period of time and prevent the release carbon dioxide gas from increasing the pressure within meat product container to an undesirable level.

It will be appreciated that the isolating container 14 shown in FIGS. 3 and 4 is shown only for purposes of example and that may other types of containers may be used to contain solid carbon dioxide making up the carbon dioxide gas releasing material. For example, solid carbon dioxide may be contained between two layers of material which are sealed around their periphery to form a pouch. Also, it should be noted again that it may be unnecessary to place the solid carbon dioxide in an isolating container. Rather, the solid carbon dioxide may simply be placed loosely in a container such as container 11 shown in FIGS. 1 and 2.

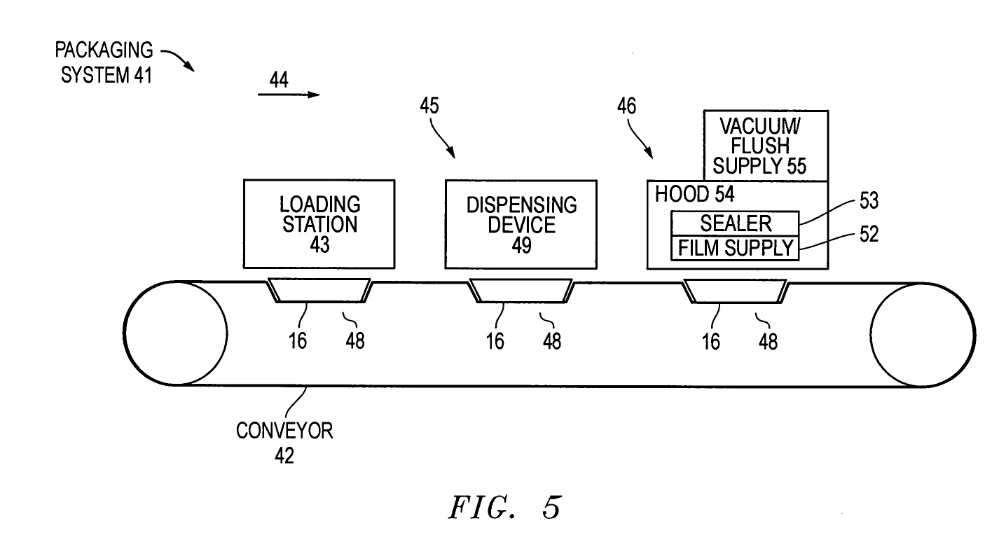

FIG. 5 provides a diagrammatic representation of a packaging system 41 that may be employed to produce a packaged product according to the invention where a tray-type package such as that shown in FIGS. 1 and 2 provides a sealing enclosure for the meat product and carbon dioxide releasing material. Packaging system 41 includes a conveyor 42 adapted to receive an open or unsealed meat product tray (such as tray 16 shown in FIGS. 1 and 2 forming a part of a sealing enclosure) at a loading station 43, and then move the tray 16 in a machine direction 44 through a dispensing station shown generally at reference numeral 45 and a sealing station shown generally at reference numeral 46. Conveyor 42 includes a number of tray carriers each having at least one tray receptacle 48 adapted to receive a tray 16. Dispensing station 45 includes a suitable dispensing device 49 for dispensing a carbon dioxide releasing material (not shown in FIG. 5) into a tray 16 at the dispensing station. The illustrated sealing station 46 includes a sealing arrangement made up of a sealing film positioning and supply device 52 and sealing device 53. Sealing station 46 further includes a vacuum/flushing arrangement made up of vacuum/flush hood 54 and a vacuum/flushing material supply 55.

In operation of the packaging system 41 shown in FIG. 5, a tray 16 containing the desired meat product (not shown in FIG. 5) is loaded into a respective receptacle 48 at loading station 43. This may be accomplished in any suitable manner within the scope of the invention. In one preferred form, tray 16 is first loaded empty or containing only an absorbent pad and then the meat product is deposited into the tray. Alternatively, tray 16 may be loaded with an absorbent pad and then the meat product, after which the tray may be loaded into a receptacle 48. Once the meat product bearing tray 16 is loaded in a receptacle 48, conveyor 42 moves the tray to dispensing station 45 where dispensing device 49 dispenses a desired amount of carbon dioxide gas releasing material into the tray with the meat product. Dispensing device 49 may comprise a device for dispensing a desired quantity of solid carbon dioxide in the form of flakes or pellets. In forms of the invention using a solid carbon dioxide container such as container 14 described in FIGS. 3 and 4, or a carbon dioxide impregnated object, dispensing device 49 may comprise a device for dropping one or more of the containers or objects into the tray 16 at the dispensing station. In any event, once tray 16 contains the meat product and the carbon dioxide releasing material, conveyor 42 moves the tray to the sealing station 46 to be sealed. The illustrated packaging system 41 first lowers hood 54 to form a chamber around the tray 16 and then applies a vacuum and/or supplies flushing gas from vacuum/flushing gas supply 55. Once the vacuum and/or flush has been applied, sealing film supply places a sealing film over the top opening of the tray 16 and sealing device 53 (such as a heated platen) seals the film around the periphery of the tray top opening. The conveyor 42 may then advance the resulting packaged meat product on to a suitable discharge arrangement (not shown) to discharge the packaged product from packaging system 41.

It will be appreciated that the invention is by no means limited to the illustrative packaging system 41 shown in FIG. 5. Many variations are possible within the scope of the present invention. Numerous types of conveyor devices, tray loading devices, dispensing devices, tray sealing devices, and vacuum/flush devices may be used within the scope of the present invention. The sequence of steps may also be varied within the scope of the invention. For example, dispensing device 49 may be adapted to dispense carbon dioxide releasing material into a tray 16 prior to the meat product being loaded into the tray. Also, the device for dispensing the carbon dioxide releasing material may be incorporated into the sealing station 46 shown in FIG. 5. In each case, however, the packaging system will provide for an arrangement to dispense carbon dioxide releasing material into the tray 16 or other portion of the sealing enclosure with the meat product and then seal the meat product and carbon dioxide releasing material together in the tray.

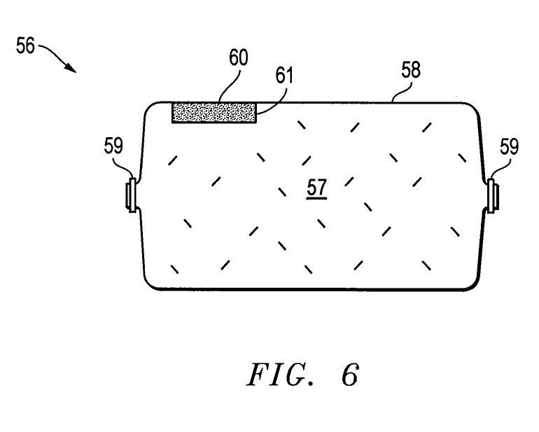

FIG. 6 shows an alternate meat package and packaged meat product 56 within scope of the present invention. This form of the invention uses a chub-type package containing a quantity of comminuted meat product 57 such as ground beef or sausage. The chub package is formed from a thin sheet of packaging material 58 such as a suitable plastic which is formed into a tube shape and then sealed or tied at each end with a suitable tying device 59 to seal in the comminuted meat product 57. According to the present invention, a carbon dioxide gas releasing material 60 is included within the area defined by packaging material 58 in position to release carbon dioxide gas into the interior of the package. Although the carbon dioxide releasing material may be loose in the are defined by packaging material 58, preferred forms of the invention include the carbon dioxide releasing material in a container 61 such as the container described above with reference to FIGS. 3 and 4, or in some other suitable carrier. The carbon dioxide releasing material container 61 or carrier is also preferably adhered or attached to the inside surface of the packaging material 58.

It will be appreciated that the two types of packages shown in the figures, the tray-type package 11 shown in FIGS. 1 and 2, and the chub-type package 56 shown in FIG. 6 are merely examples of the packages with which the present invention may be employed. Generally, the package requires only at least one package material that is formed around a meat product to seal in the meat product and prevent liquids and gasses from escaping from the package. There are numerous variations within the two general types of packages described above in reference to the figures. For example, a tray-type package may include a tray having lower side walls so that the sealing film that provides a seal around the periphery of the tray actually makes contact with the meat product resting on the tray.

The present invention has application to substantially any type of meat product. However, the invention has particular application to meat products that have been treated with a pH increasing material such as an ammonia-based pH increasing material, either alone or with oxygen or other materials. The invention also has particular application to meat products that have been treated with carbon monoxide, either alone or with pH increasing materials. Although not limited to these processes, meat products packaged according to the present invention may be treated with a pH increasing material as described in U.S. Pat. No. 6,142,067, or as described in pending U.S. patent application Ser. No. 10/379,761, filed Mar. 5, 2003. Meat products packaged according to the present invention may be treated with carbon monoxide in any suitable process, particularly the process disclosed in pending U.S. patent application Ser. No. 10/795,000, filed Mar. 5, 2004. The entire content of this patent and each of these patent applications is incorporated herein by this reference.

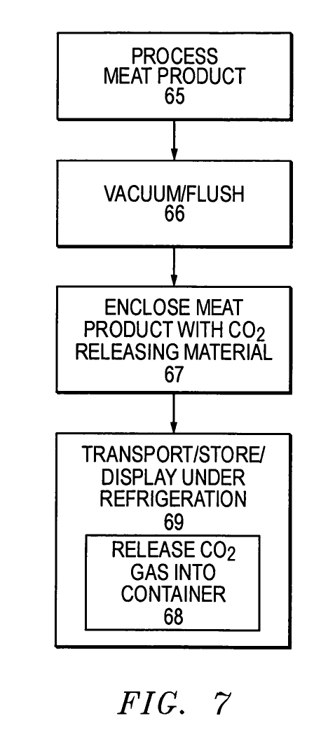

A method for packaging meat products according to the present invention may be described with reference to the block diagram of FIG. 7 together with the packaging arrangements shown in FIGS. 1, 2, and 6. A method embodying the principles of the invention includes receiving a meat product that has been processed in any suitable process at block 65 and sealing the meat product in a container as indicated at block 67. The meat product may be placed under a vacuum or flushed with a suitable flushing material as indicated at block 66 prior to being sealed in the enclosure or package with the carbon dioxide releasing material. The method further includes releasing carbon dioxide gas as indicated at block 68. The gas is released from a source contained inside the container to maintain a carbon dioxide gas presence in an atmosphere in the container. This release of carbon dioxide gas may occur while the packaged meat product is in transit to users, while the packaged meat product is being stored, or while the packaged meat product is being displayed to potential purchasers as indicated at block 69.

The carbon dioxide presence in the sealed container is preferably sufficient to maintain a slight positive pressure in the container (such as 11 in FIGS. 1 and 2, or 56 in FIG. 6) or at least a pressure substantially equal to atmospheric pressure. The positive or at least neutral pressure is preferred to reduce purge from the meat product in the container or package. It will be appreciated that other gasses may be included in the atmosphere in the meat product container or package. In particular, gasses such as Nitrogen, Helium, and Argon, which are not significantly absorbed by the meat product, may be used to augment the pressure provided by the carbon dioxide gas.

The step of releasing carbon dioxide gas may include releasing carbon dioxide gas from a quantity of solid carbon dioxide within the sealed container (11 in FIGS. 1 and 2 and 45 in FIG. 5). The amount of solid carbon dioxide that may be required to maintain the desired carbon dioxide gas presence in the sealed container or package will depend upon a number of factors including the size of the package, the amount of meat product included in the container/package, the pH of the meat product, and the time the packaged meat product will be maintained in the container/package. However, in tests it has been found that approximately three-quarter to one (0.75 to 1.0) grams of solid carbon dioxide produces and maintains the desired slight positive pressure in a tray-type package measuring approximately 9.5 inches by 5.5 inches by 2.0 inches and containing approximately 1.5 pounds of beef steak, where the meat was injected with ammonium hydroxide solution to produce a pH of 6.3 to 7.8 in the meat, and the package stored at approximately twenty-eight to thirty-five degrees Fahrenheit.

Regardless of the amount of solid carbon dioxide used in the container/package, the solid carbon dioxide may be loose in the container/package so it is released directly to the container/package atmosphere. Alternatively, the solid carbon dioxide is contained in an isolating container such as container 14 shown in FIGS. 3 and 4 and thus the step of releasing the carbon dioxide gas includes releasing carbon dioxide gas from the isolating container either within the container/package or attached to the container/package.

In some cases, sufficient carbon dioxide gas may be impregnated into a suitable carrier material so that the carrier material may release sufficient carbon dioxide gas to provide the desired carbon dioxide gas presence in the container/package. The method of the invention may thus include releasing carbon dioxide gas from such a carbon dioxide gas carrier material held within the sealed container/package.

The processing indicated at block 65 in FIG. 7 may comprise any processing that may be applied to a meat product prior to packaging. The processing may include increasing the pH of the meat product by any suitable method, reducing the pH, and/or treating the meat product with carbon monoxide, and/or oxygen. It should also be noted that pH modifying materials and carbon monoxide may be included in the sealed container/package itself and thus the pH modifying treatment and carbon monoxide treatment may occur or continue even after the meat product is sealed in the container/package.

The above described preferred embodiments are intended to illustrate the principles of the invention, but not to limit the scope of the invention. Various other embodiments and modifications to these preferred embodiments may be made by those skilled in the art without departing from the scope of the present invention.

1. A packaged meat product including:
(a) a sealed container;
(b) a meat product in an interior of the sealed container; and
(c) a carbon dioxide gas releasing material in the sealed container.

2. The packaged meat product of claim 1 wherein the carbon dioxide gas releasing material comprises solid carbon dioxide.

3. The packaged meat product of claim 2 wherein the solid carbon dioxide is contained within the sealed container in a carrier device having at least one carbon dioxide gas permeable boundary.

4. The packaged meat product of claim 1 wherein the carbon dioxide gas releasing material comprises a carrier material impregnated with carbon dioxide gas.

5. The packaged meat product of claim 1 wherein the meat product comprises a meat product that has been treated with a pH increasing material.

6. The packaged meat product of claim 5 wherein the pH increasing material comprises an ammonia based pH increasing material.

7. The packaged meat product of claim 1 wherein the meat product comprises a meat product that has been treated with carbon monoxide.

8. The packaged meat product of claim 1 wherein the sealed container comprises a tray-type package including a tray that defines a tray opening and further including a sealing film material sealed over the tray opening.

9. The packaged meat product of claim 1 wherein the sealed container comprises a chub package.

10. An apparatus including:
(a) a sealing arrangement for sealing a meat product in a sealing enclosure; and
(b) a dispensing device for placing a carbon dioxide releasing material into a portion of the sealing enclosure immediately prior to sealing the meat product in the sealing enclosure.

11. The apparatus of claim 10 wherein the sealing arrangement includes a sealing film supply and a sealing device for sealing the film to a tray.

12. The apparatus of claim 10 further including a vacuum chamber and vacuum supply for applying a vacuum to the meat product prior to sealing the meat product in the sealing enclosure.

13. The apparatus of claim 10 further including a flushing chamber and flushing gas supply for applying a flushing gas to the meat product prior to sealing the meat product in the sealing enclosure.

14. The apparatus of claim 10 wherein the dispensing device is adapted to dispense a quantity of solid carbon dioxide into the sealing enclosure.

15. The apparatus of claim 10 wherein the dispensing device is adapted to release a carbon dioxide carrier into the sealing enclosure.

16. A method for packaging meat products, the method including steps of:
(a) sealing a meat product in a container; and
(b) releasing carbon dioxide gas from a source contained inside the container to maintain a carbon dioxide gas presence in an atmosphere in the container.

17. The method of claim 16 wherein the step of releasing carbon dioxide gas includes releasing carbon dioxide gas from a quantity of solid carbon dioxide within the sealed container.

18. The method of claim 17 wherein the step of releasing carbon dioxide gas from the solid carbon dioxide includes releasing carbon dioxide gas from an isolating container within which the solid carbon dioxide gas is contained.

19. The method of claim 16 wherein the step of releasing carbon dioxide gas includes releasing carbon dioxide gas from a material held within the sealed container which has been impregnated with carbon dioxide gas.

20. The method of claim 16 further including the step of applying a pH increasing material to the meat product either before or after sealing the meat product in the container.

21. The method of claim 20 wherein the pH increasing material is an ammonia-based pH increasing material.

22. The method of claim 16 further including the step of applying carbon monoxide to the meat product either before or after sealing the meat product in the container.

23. The method of claim 16 wherein the step of sealing the meat product in the container includes placing the meat product in a tray of a tray-type package and then sealing a film material over an opening of the tray.

24. The method of claim 16 wherein the step of sealing the meat product in the container includes sealing the meat product in a chub package.

25. The method of claim 16 further including the step of applying a vacuum to the meat product or applying a flushing gas to the meat product immediately prior to sealing the meat product in the container.
